(19) United States
(12) Patent Application Publication
(10) Pub. No.: US 2026/0241780 A1
(43) Pub. Date: Aug. 20, 2026

(54) DRIVE UNIT FOR A VEHICLE AND VEHICLE WITH SUCH A DRIVE UNIT

(71) Applicant: ZF Friedrichshafen AG, Friedrichshafen (DE)

(72) Inventor: Stefan Renner, Bodman-Ludwigshafen (DE)

(73) Assignee: ZF Friedrichshafen AG, Friedrichshafen (DE)

(21) Appl. No.: 19/543,628

(22) Filed: Feb. 18, 2026

(30) Foreign Application Priority Data
Feb. 19, 2025 (DE) 10 2025 106 150.5

(51) Int. Cl. B60K 1/02; B60K 17/28

(52) U.S. Cl. CPC B60K 1/02; B60K 17/28

(57) ABSTRACT

A drive unit for a vehicle (100) has a first electric machine (EM1), a second electric machine (EM2), and a transmission (SG) with a first drive input shaft (An1) for connection to the first electric machine (EM1), a second drive input shaft (An2) for connection to the second electric machine (EM2), a drive output shaft (Ab), a power take-off shaft (NAb) connected to the first drive input shaft (An1), a first sliding sleeve (SM1) having three shift positions (1a, 1b, 1c), a second sliding sleeve (SM2) having two shift positions (2a, 2b), and two planetary gearsets (PS1, PS2). A first planetary gearset (PS1) has a first sun gear shaft (SO1), a first ring gear shaft (HR1), and a first web shaft (ST1), and a second planetary gearset (PS2) has a second sun gear shaft (SO2), a second ring gear shaft (HR2), and a second web shaft (ST2).

### RELATED APPLICATIONS

This application claims the benefit of and right of priority under 35 U.S.C. § 119 to German Patent Application no. 10 2025 106 150.5, filed on 19 Feb. 2025, the contents of which are incorporated herein by reference in its entirety.

### FIELD OF THE DISCLOSURE

The invention relates to a drive unit for a vehicle and a vehicle with such a drive unit. The drive unit comprises two electric machines, a manual transmission, and a power take-off drive output shaft designed to supply drive power to a power take-off drive output module.

### BACKGROUND

Power take-off drive output modules are designed to drive an auxiliary aggregate on or outside the vehicle by means of the drive machine of the vehicle. For example, a pump, a compressor, a shredder, a winch, or a pumping system can be operated. Power take-off drive output modules are often used with special-purpose vehicles such as fire-engines, self-propelling concrete pumps, or vacuum and sweeping vehicles. With such vehicles, besides their driving function, a further function is paramount. The drive power of the drive machine is directed toward the power take-off aggregate or to the drive wheels of the vehicle, as necessary. Electric central drive systems of planetary design have no connection facility for a power take-off module, but rather, an additional drive unit which as a rule is only used for the power take-off module. This is comparatively expensive and elaborate.

For example, DE 10 2023 200 355 A1 discloses an electric central drive system of planetary design. This comprises a first and a second electric machine and a manual transmission with four shifting elements and two planetary gearsets coupled with one another, wherein the first planetary gearset comprises a first sun gear shaft, a first ring gear shaft, and a first web shaft, whereas the second planetary gearset comprises a second sun gear shaft, a second ring gear shaft, and a second web shaft. The second sun gear shaft is connected rotationally fixed to the first web shaft, and the second ring gear shaft is connected rotationally fixed to a stationary component. When actuated, the first shifting element connects the first ring gear shaft to a stationary component in order to engage a first gear. When actuated, the second shifting element connects the first ring gear shaft to the second web shaft in order to engage a second gear. The third shifting element and the fourth shifting element are actuated at the same time in order to block the first planetary gearset and engage a third gear.

### SUMMARY

The purpose of the present invention is to further develop a drive unit for a vehicle. In particular, a power take-off should be integrated and extend the functional range. This objective is achieved by the features specified in the independent claim 1. Advantageous embodiments are the object of the dependent claims, the description given in what follows and the figures.

According to a first aspect, a drive unit for a vehicle is provided, which comprises a first electric machine, a second electric machine, a transmission with a first drive input shaft for connecting the first electric machine, a second drive input shaft for connecting the second electric machine, a drive output shaft, a power take-off drive output shaft connected to the first drive input shaft, a first sliding sleeve with three shift positions, a second sliding sleeve with two shift positions, and two planetary gearsets coupled with one another, wherein the first planetary gearset has a first sun gear shaft, a first ring gear shaft, and a first web shaft, and whereas the second planetary gearset has a second sun gear shaft, a second ring gear shaft, and a second web shaft. The first web shaft carries a number of planetary gearwheels which mesh with the first sun gear shaft and with the first ring gear shaft. The second web shaft carries a number of planetary gearwheels which mesh with the second sun gear shaft and with the second ring gear shaft. In an embodiment, the first sun gear shaft is connected rotationally fixed to the first drive input shaft, the first web shaft is connected rotationally fixed to the second sun gear shaft, the second web shaft is connected rotationally fixed to the drive output shaft, and the second ring gear shaft is connected rotationally fixed to a stationary component. A “stationary component” is understood to be a component which is immobilized, in particular rotationally fixed to or integral with part of a housing.

In the context of the invention, a “shaft” is understood to be a rotatable component of the transmission, by means of which respective associated components of the transmission are connected rotationally fixed to one another or by means of which such a connection can be made when one of the shifting elements is actuated. The shaft concerned can connect the components to one another axially or radially, or even both axially and radially. Thus, the shaft concerned can be present as an intermediate element by means of which a component can be connected, for example radially. In this context the term “shaft” does not exclude that the components to be connected can be made integrally. In particular, two or more shafts connected rotationally fixed to one another can be made integrally.

In each case, a neutral position is provided between two shift positions of the first sliding sleeve. Thus, the first sliding sleeve has a total of five positions, namely three shift positions and two neutral positions. In the first shift position of the first sliding sleeve, the first ring gear shaft is connected rotationally fixed to a stationary component in order to engage a first gear. In the second shift position of the first sliding sleeve, the first ring gear shaft is connected rotationally fixed to the drive output shaft in order to engage a second gear. In the third shift position of the first sliding sleeve the first ring gear shaft is connected rotationally fixed to the first web shaft and the second sun gear shaft in order to block the first planetary gearset and to engage a third gear in the form of a direct gear. The three gears have different gear ratios and are used for the driving propulsion of the vehicle.

A neutral position is provided between the two shift positions of the second sliding sleeve. Thus, the second sliding sleeve has a total of three positions, namely, two shift positions and a neutral position. In the first shift position of the second sliding sleeve, the second drive input shaft is connected rotationally fixed to the first ring gear shaft in order to enable a powershift to be carried out. In the second shift position of the second sliding sleeve, the two drive input shafts are connected rotationally fixed to one another, so enabling the synchronous driving of the two electric machines.

The two sliding sleeves are of interlocking design and have interlocking claws, which in the shift position concerned cooperate with respectively corresponding claw teeth in an interlocked manner in order to produce a rotationally fixed connection between two shafts or of a shaft with a stationary component. Thus, the claw tooth array concerned, with which the respective sliding sleeve cooperates with interlock, is understood to be an interlocking shifting element which can be either in an open or in a closed condition. By virtue of interlocking shifting elements, the efficiency of the drive unit is increased since drag losses are reduced. In particular, interlocking shifting elements are more compact, are designed for optimum efficiency, and have cost advantages compared with frictional shifting elements. Each sliding sleeve is displaced axially by a single actuator which moves it to the required position of the sliding sleeve concerned, in particular the appropriate shift position. Since only two actuators are used for shifting, the compactness and efficiency of the transmission are increased still further.

The electric central drive comprises two electric machines, and a transmission which provides three gears and various drive functions for the power take-off shaft. Regardless of the particular position of the sliding sleeve concerned, the power take-off shaft is always drivingly connected to the first drive input shaft. By means of the first sliding sleeve various gears for driving operation are engaged, and by means of the second sliding sleeve the second electric machine can be switched in as a supplement.

For example, when the vehicle is operating at a standstill, to drive the power take-off the first sliding sleeve is in a neutral position between two of its shift positions and the second sliding sleeve is either in its neutral position or in its second shift position. The neutral positions of the first sliding sleeve are between its first and second shift positions and between its second and third shift positions. If the first sliding sleeve is in a neutral position, no gear is engaged, so that the drive output shaft cannot be driven. If the second sliding sleeve is also in its neutral position, i.e., between the first and second shift positions of the second sliding sleeve, the power take-off shaft is driven solely by the first electric machine. When the second sliding sleeve is in its second shift position, the two drive input shafts are connected rotationally fixed to one another so that the power take-off shaft can be driven by both electric machines at the same time. This is particularly advantageous when additional drive power for driving the power take-off shaft is needed while the vehicle is in a stationary operating mode.

In an embodiment, when the vehicle is not operating in a stationary mode, to drive the power take-off shaft the first sliding sleeve is moved to one of its three shift positions and the second sliding sleeve to its second shift position or to its neutral position. When the first sliding sleeve is in one of its three shift positions, one of the three gears is engaged so that, depending on the position of the second sliding sleeve (second shift position or neutral position of the second sliding sleeve) the drive output shaft can be driven either by both electric machines at the same time or only by the first electric machine. For example, in the neutral position of the second sliding sleeve and in one of the three shift positions of the first sliding sleeve, the power take-off shaft and also the drive output shaft are driven only by the first electric machine because the second electric machine is decoupled by the second sliding sleeve. For example, in the second shift position of the second sliding sleeve and one of the three shift positions of the first sliding sleeve, the power take-off shaft and the drive output shaft can be driven by both electric machines because the two drive output shafts are connected rotationally fixed to one another. This is particularly advantageous when additional drive power for driving the power take-off shaft is needed during a stationary operating mode. In the second shift position and in the neutral position of the second sliding sleeve, the rotation speed of the power take-off shaft in the gear concerned is proportional to the rotation speed of the drive output shaft, in particular to the driving speed of the vehicle.

In an embodiment, when not in stationary operation of the vehicle, in order to drive the power take-off shaft, the first sliding sleeve is in a neutral position between two of the three shift positions, and the second sliding sleeve is in its first shift position. These positions of the two sliding sleeves enable electrodynamic driving operation by the simultaneous driving of both electric machines. Depending on the rotation speeds and the rotation speed ratio of the two electric machines, the driving speed of the vehicle is determined, and the rotation speed of the power take-off shaft can be kept constant.

In an embodiment, the power take-off shaft is arranged with its axis parallel to the first drive input shaft and is drivingly connected via a gear ratio step to the first drive input shaft. The gear ratio step is preferably in the form of a constant gear ratio and comprises at least two gearwheels that mesh with one another. The first gearwheel is arranged, for example, rotationally fixed on the first drive input shaft and the second gearwheel is arranged, for example, rotationally fixed on the power take-off shaft. The power take-off shaft is designed for the connection of a power take-off module. By virtue of the at least one gear ratio step at least an axial offset and optionally also a gear ratio is produced.

According to an embodiment, the two electric machines are arranged coaxially with one another. In particular, the two electric machines are arranged axially adjacent to one another. Preferably, the two electric machines are accommodated in a common housing. Preferably, the first drive input shaft is mounted in the housing by means of three bearings and the second drive input shaft is mounted in the housing by means of two bearings, in such manner that between the two electric machines a housing wall is formed to receive a respective bearing of the drive input shaft concerned. In that way the drive unit can be made still more compact.

In an embodiment, the two planetary gearsets are arranged radially inside the first electric machine. Thus, the two planetary gearsets are configured radially nested with the first electric machine. For example, the two electric machines are designed with internal rotors, i.e., with their rotors on the inside. In that way, the compactness of the drive unit can be increased further.

In an embodiment, the two sliding sleeves are arranged at least partially radially inside the second electric machine. Thus, the two sliding sleeves are radially nested within the second electric machine. Preferably, the first sliding sleeve is arranged radially inside the second sliding sleeve. For example, at least one of the two sliding sleeves can overlap axially, at least partially, with the first electric machine. In that way the drive unit can be made even more compact.

According to a second aspect, a vehicle with a drive unit as described in the first aspect is provided. The above definitions and descriptions regarding technical effects, advantages and advantageous embodiment of the drive unit according to the invention also apply analogously to the vehicle according to the invention. The vehicle is preferably a special-purpose vehicle or a utility vehicle and comprises a power take-off module to which the power take-off shaft can be drivingly connected.

### BRIEF DESCRIPTION OF THE DRAWINGS

An advantageous embodiment of the invention, which is described below, is illustrated in the drawings, in which the same or similar elements are denoted by the same indexes, and which show:

FIG. 1: A greatly simplified schematic representation of a vehicle, and

FIGS. 2 to 6: Different shift positions of a greatly simplified representation of a drive unit.

### DETAILED DESCRIPTION

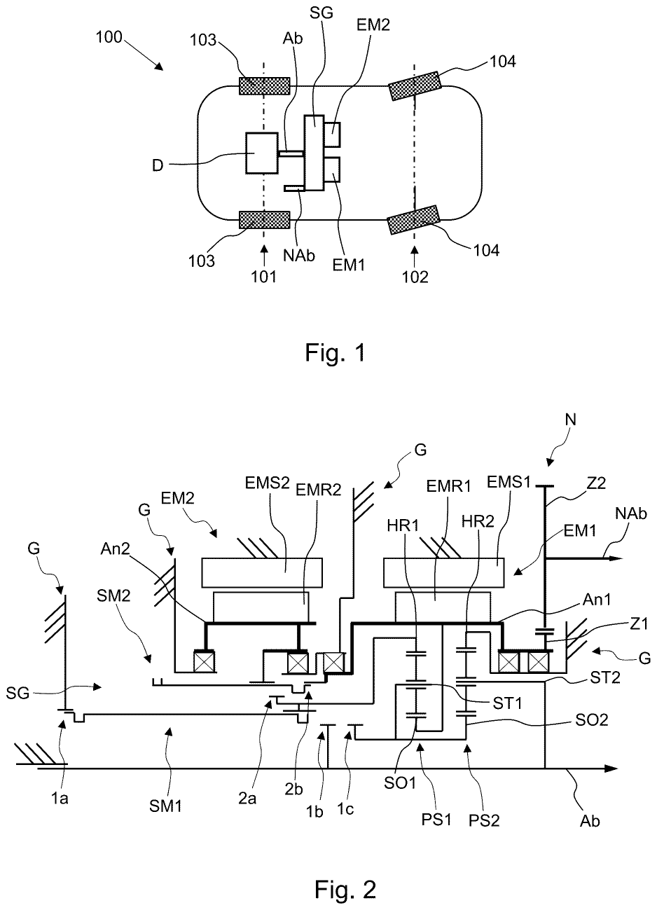

FIG. 1 shows a vehicle 100 with a first vehicle axle 101 having two vehicle wheels 103 and a second vehicle axle 102 with two vehicle wheels 104. In this case the first vehicle axle 101 is the rear drive axle of the vehicle 100 and comprises a drive unit with a first electric machine EM1, a second electric machine EM2 and a transmission SG which has a drive output shaft Ab and a power take-off shaft NAb. The drive output shaft Ab is drivingly connected by way of a differential D to the vehicle wheels 103 of the first vehicle axle 101. For example, the vehicle 100 is in the form of an electric vacuum truck, wherein the power take-off shaft is designed to drive vacuum equipment (no more of which is shown).

FIG. 2 shows the drive unit of the vehicle 100 shown in FIG. 1. The first electric machine EM1 has a first stator EMS1 and a first rotor EMR1, which is arranged radially inside the first stator EMS1. The second electric machine EM2 has a second stator EMS2 and a second rotor EMR2, which is arranged radially inside the second stator EMS2. The transmission SG of the drive unit has a first drive input shaft An1 for connection to the first electric machine EM1, a second drive input shaft An2 for connection to the second electric machine EM2, a drive output shaft Ab, the power take-off shaft NAb which is connected to the first drive input shaft An1, a first sliding sleeve SM1 which has three shift positions 1a, 1b, 1c, a second sliding sleeve SM2 which has two shift positions 2a, 2b, and two planetary gearsets PS1, PS2 which are coupled to one another and are arranged axially adjacent to one another.

The first planetary gearset PS1 has a first sun gear shaft SO1, a first ring gear shaft HR1, and a first web shaft ST1, such that the first web shaft ST1 carries a number of planetary gearwheels which mesh with the first sun gear shaft SO1 and with the first ring gear shaft HR1. The second planetary gearset PS2 has a second sun gear shaft SO2, a second ring gear shaft HR2, and a second web shaft ST2, such that the second web shaft ST2 carries a number of planetary gearwheels which mesh with the second sun gear shaft SO2 and with the second ring gear shaft HR2. The first sun gear shaft SO1 is connected rotationally fixed to the first drive input shaft An1, the first web shaft ST1 is connected rotationally fixed to the second sun gear shaft SO2, the second web shaft ST2 is connected rotationally fixed to the drive output shaft Ab, and the second ring gear shaft HR2 is connected rotationally fixed to a stationary component in the form of a housing G. The first drive input shaft An1 is connected rotationally fixed to the first rotor EMR1, and the second drive input shaft An2 is connected rotationally fixed to the second rotor EMR2. The first drive input shaft An1 is supported and mounted rotatably in the housing G by means of three bearings. The second drive input shaft An2 is supported and mounted rotatably in the housing G by means of two bearings.

The power take-off shaft NAb is arranged with its axis parallel to the first drive input shaft An1 and is drivingly connected to the first drive input shaft An1 by way of a gear ratio step N. The gear ratio step N is in the form of a constant gear ratio and comprises two gearwheels Z1, Z2, which mesh with one another. The first gearwheel Z1 is connected rotationally fixed to the first drive input shaft An1, and the second gearwheel is connected rotationally fixed to the power take-off shaft NAb. The gear ratio step creates a gear ratio and an axial offset. The two electric machines EM1, EM2 are arranged coaxially with one another and with the transmission SG. The two planetary gearsets PS1, PS2 are arranged radially inside the first electric machine EM1 and overlap the first electric machine EM1 axially. The two sliding sleeves SM1, SM2 are arranged, at least partially, radially inside the second electric machine EM2 and overlap the second electric machine EM2 axially. In the present case the first sliding sleeve SM1 is arranged radially inside the second sliding sleeve SM2. This increases the compactness of the drive unit.

The first sliding sleeve SM1 has a total of five axial positions, namely the three shift positions 1a, 1b, 1c and two neutral positions, such that a respective neutral position is provided between each pair of shift positions of the first sliding sleeve SM1. By axial displacement of the first sliding sleeve SM1 by means of a first actuator (not shown), the position of the first sliding sleeve SM1 can be set. In FIG. 2 the first sliding sleeve SM1 is at the first shift position 1a.

The second sliding sleeve SM2 has a total of three axial positions, namely, two shift positions 2a, 2b and a neutral position between the two shift positions 2a, 2b of the second sliding sleeve SM2. By axial displacement of the second sliding sleeve SM2 by means of a second actuator (not shown), the position of the second sliding sleeve SM2 can be set. In FIG. 2 the second sliding sleeve SM2 is at the second shift position 2b.

In the present case, since the second sliding sleeve SM2 is at its second shift position 2b, the two drive input shafts An1, An2 are connected rotationally fixed to one another and the first ring gear shaft HR1 is connected rotationally fixed to a stationary component in the form of a housing G since the first sliding sleeve SM1 is at its first shift position 1a. These positions, i.e. the presence of the first sliding sleeve SM1 at its first shift position 1a and the presence of the second sliding sleeve SM2 at its second shift position 2b, are provided in order to drive the drive output shaft Ab and the power take-off shaft NAb by the two electric machines EM1, EM2 at the same time in a first gear.

If the first sliding sleeve SM1 is displaced axially two positions to the right, first of all the first ring gear shaft HR1 is decoupled from the stationary component in the neutral position and then the first ring gear shaft HR1 is connected rotationally fixed to the drive output shaft Ab in the second shift position 1b, in order to engage a second gear. This changes the gear ratio, so that the drive output shaft Ab and the power take-off shaft NAb can be driven by the two electric machines EM1, EM2 in the second gear.

If the first sliding sleeve SM1 is displaced axially two positions farther to the right, then first of all the first ring gear shaft HR1 is decoupled from the drive output shaft in the neutral position and then a rotationally fixed connection is formed between the first ring gear shaft HR1 and the first web shaft ST1 and the second sun gear shaft SO2 in the third shift position 1c, in order to engage a third gear. Thus, the gear ratio is changed, and the drive output shaft Ab and the power take-off shaft NAb can be driven by the two electric machines EM1, EM2 in the third gear.

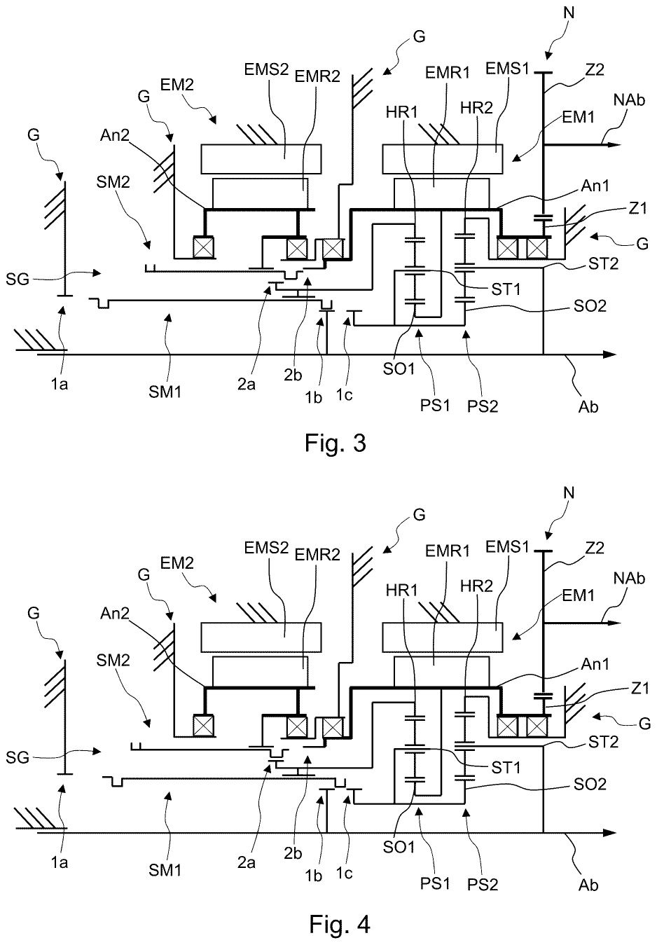

FIG. 3 shows the drive unit of FIG. 2, to which reference is made, wherein the second sliding sleeve SM2 is in the neutral position, i.e., compared with FIG. 2 it has been displaced one position to the left, whereas the first sliding sleeve SM1 is in its second shift position, i.e., compared with FIG. 2 it has been displaced two positions to the right. Since the first sliding sleeve SM1 is in its second shift position 1b and the second sliding sleeve SM2 is in its neutral position, i.e., between the first and second shift positions 2a, 2b, the second electric machine EM2 is decoupled from the transmission SG so that if the vehicle 100 is not operating in the stationary mode only the first electric machine EM1 can be used to drive the drive output shaft AB and the power take-off shaft NAb in the second gear.

FIG. 4 shows the drive unit of FIG. 2, to which reference is made, wherein the second sliding sleeve SM2 is in its first shift position 2a, i.e., compared with FIG. 2 it has been displaced two positions to the left, and the first siding sleeve SM1 is in its second neutral position, i.e., compared with FIG. 2 it has been displaced three positions to the right. Since the second sliding sleeve SM2 is in its first shift position 2a and the first sliding sleeve SM1 is in its second neutral position, i.e., between the second and third shift positions 1b, 1c, the second drive input shaft An2 is connected rotationally fixed to the first ring gear shaft HR1. In this position a drive output-supported shift, i.e., a powershift is carried out. In particular, by operating the two electric machines EM1, EM2 at the same time an electro-dynamic driving operation is realized, such that depending on the rotation speeds and the rotation speed ratio of the two electric machines EM1, EM2 the driving speed of the vehicle is determined, whereas the rotation speed of the power take-off shaft NAb can be kept constant.

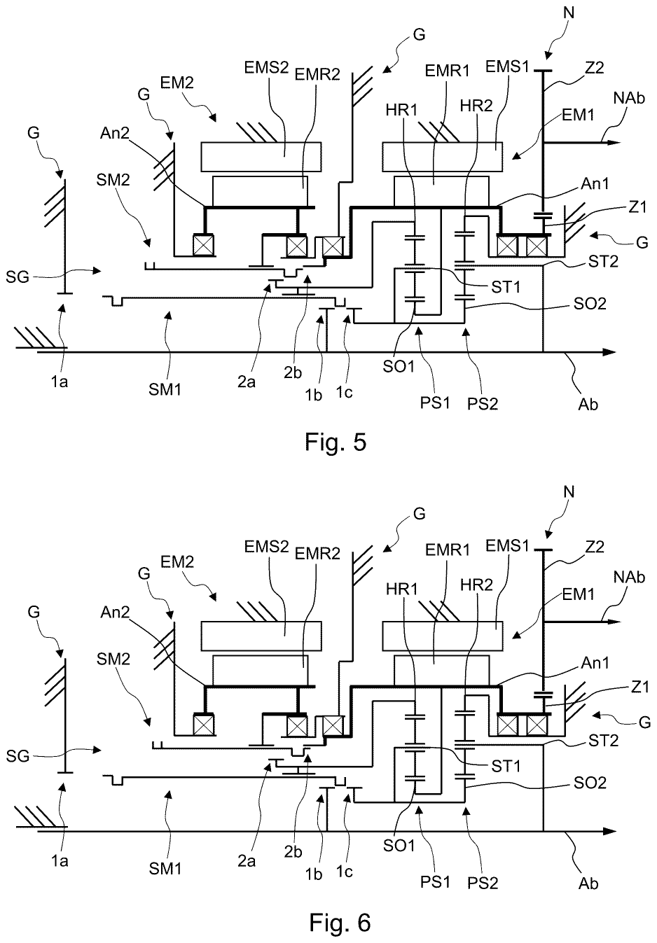

FIG. 5 shows the drive unit of FIG. 2, to which reference is made, wherein the second sliding sleeve SM2 is in its neutral position, i.e., compared with FIG. 2 it has been displaced one position to the left, and the first sliding sleeve SM1 is in its second neutral position, i.e., compared with FIG. 2 it has been displaced three positions to the right. Since both sliding sleeves SM1 and SM2 are in respective neutral positions, the second drive input shaft An2 is decoupled from the transmission SG and does not apply any torque to the first ring gear shaft HR1, so that the drive output shaft Ab is decoupled from both electric machines EM1, EM2. In this stationary operating mode of the vehicle the first electric machine EM1 can be used to drive the power take-off shaft NAb.

FIG. 6 shows the drive unit of FIG. 2, to which reference is made, wherein the second sliding sleeve SM2 is in its second shift position 2b, i.e., the same as shown in FIG. 2, while the first sliding sleeve SM1 is in its second neutral position, i.e., compared with FIG. 2 it has been displace three positions to the right. Since the first sliding sleeve SM1 is in a neutral position and the second sliding sleeve SM2 connects the two drive input shafts An1, An2 rotationally fixed to one another, no torque is applied to the first ring gear shaft HR1 so that the drive output shaft Ab is decoupled from the two electric machines EM1, EM2. In this stationary operating mode of the vehicle the two electric machines EM1, EM2 can be used to drive the power take-off shaft NAb. This is particularly advantageous if additional drive power is needed for the operation of the power take-off shaft NAb while the vehicle is in stationary operation.

Indexes

| | |
|---|---|
| An1 | First drive input shaft |
| An2 | Second drive input shat |
| Ab | Drive output shaft |
| NAb | Power take-off shaft |
| SG | Transmission |
| 100 | Vehicle |
| 101 | First axle |
| 102 | Second axle |
| 103 | Vehicle wheel on the first axle |
| 104 | Vehicle wheel on the second axle |
| EM1 | First electric machine |
| EMS1 | Stator of the first electric machine |
| EMR1 | Rotor of the first electric machine |
| EM2 | Second electric machine |
| EMS2 | Stator of the second electric machine |
| EMR2 | Rotor of the second electric machine |
| PS1 | First planetary gearset |
| SO1 | First sun gear shaft |
| HR1 | First ring gear shaft |
| ST1 | First web shaft |
| PS2 | Second planetary gearset |
| SO2 | Second sun gear shaft |
| HR2 | Second ring gear shaft |
| ST2 | Second web shaft |
| G | Housing |
| SM1 | First sliding sleeve |
| 1a | First shift position of the first sliding sleeve |
| 1b | Second shift position of the first sliding sleeve |
| 1c | Third shift position of the first sliding sleeve |
| SM2 | Second sliding sleeve |
| 2a | First shift position of the second sliding sleeve |

1. A drive unit for a vehicle (100), comprising:
a first electric machine (EM1);
a second electric machine (EM2); and
a transmission (SG) comprising:
a first drive input shaft (An1) configured for connection to the first electric machine (EM1),
a second drive input shaft (An2) configured for connection to the second electric machine (EM2),
a drive output shaft (Ab), a power take-off shaft (NAb) connected to the first drive input shaft (An1),
a first sliding sleeve (SM1) having three shift positions (1a, 1b, 1c),
a second sliding sleeve (SM2) having two shift positions (2a, 2b),
a first planetary gearset (PS1) with a first sun gear shaft (SO1), a first ring gear shaft (HR1), and a first web shaft (ST1), and
a second planetary gearset (PS2) with a second sun gear shaft (SO2), a second ring gear shaft (HR2), and a second web shaft (ST2);
wherein, in the first shift position (1a) of the first sliding sleeve (SM1) the first ring gear shaft (HR1) is connected rotationally fixed to a stationary component in order to engage a first gear;
wherein, in the second shift position (1b) of the first sliding sleeve (SM1) the first ring gear shaft (HR1) is connected rotationally fixed to the drive output shaft (Ab) in order to engage a second gear;
wherein, in the third shift position (1c) of the first sliding sleeve (SM1) the first ring gear shaft (HR1) is connected rotationally fixed to the first web shaft (ST1) and to the second sun gear shaft (SO2) in order to engage a third gear;
wherein, in the first shift position (2a) of the second sliding sleeve (SM2) the second drive input shaft (An2) is connected rotationally fixed to the first ring gear shaft (HR1);
wherein, in the second shift position (2b) of the second sliding sleeve (SM2) the two drive input shafts (An1, An2) are connected rotationally fixed to one another; and
wherein, between the two shift positions (2a, 2b) of the second sliding sleeve (SM2), a neutral position is provided for decoupling the second drive input shaft (An2).

2. The drive unit according to claim 1, wherein, in order to drive the power take-off shaft (NAb) when the vehicle (100) is operating in a stationary mode, the first sliding sleeve (SM1) is moved to a neutral position between two of its three shift positions (1a, 1b, 1c) and the second sliding sleeve is either in its neutral position or in its second shift position (2b).

3. The drive unit according to claim 1, wherein, in order to drive the power take-off shaft (NAb) when the vehicle (100) is not operating in a stationary mode, the first sliding sleeve (SM1) is moved to one of its three shift positions (1a, 1b, 1c) and the second sliding sleeve (SM2) is in its second shift position (2b) or in its neutral position.

4. The drive unit according to claim 1, wherein, in order to drive the power take-off shaft (NAb) when the vehicle (100) is not operating in a stationary mode, the first sliding sleeve (SM1) is moved to a neutral position between two of its three shift positions (1a, 1b, 1c) and the second sliding sleeve (SM2) is in its first shift position (2a).

5. The drive unit according to claim 1, wherein the first sun gear shaft (SO1) is connected rotationally fixed to the first drive input shaft (An1), wherein the first web shaft (ST1) is connected rotationally fixed to the second sun gear shaft (SO2), wherein the second web shaft (ST2) is connected rotationally fixed to the drive output shaft (Ab), and wherein the second ring gear shaft (HR2) is connected rotationally fixed to a stationary component.

6. The drive unit according to claim 5, wherein the power take-off shaft (NAb) is arranged with its axis parallel to the first drive input shaft (An1) and is drivingly connected to the first drive input shaft (An1) by way of a gear ratio step (N).

7. The drive unit according to claim 1, wherein the two electric machines (EM1, EM2) are arranged coaxially with one another.

8. The drive unit according to claim Z, wherein the two planetary gearsets (PS1, PS2) are arranged radially inside the first electric machine (EM1).

9. The drive unit according to claim 1, wherein the two sliding sleeves (SM1, SM2) are arranged at least partially radially inside the second electric machine (EM2).

10. A vehicle (100) comprising the drive unit according to claim 1.
